(19) United States
(12) Patent Application Publication
(10) Pub. No.: US 2026/0042340 A1
(43) Pub. Date: Feb. 12, 2026

(54) WEATHER STRIP

(71) Applicant: NISHIKAWA RUBBER CO., LTD., Hiroshima-shi (JP)

(72) Inventors: Yusuke MURAI, Hiroshima-shi (JP); Keigo MATSUMOTO, Hiroshima-shi (JP)

(21) Appl. No.: 19/288,231

(22) Filed: Aug. 1, 2025

(30) Foreign Application Priority Data
Aug. 10, 2024 (JP) 2024-134712
Oct. 23, 2024 (JP) 2024-187000

(51) Int. Cl. B60J 10/16; B60J 10/50; B60J 10/80

(52) U.S. Cl. CPC B60J 10/16; B60J 10/50; B60J 10/80

(57) ABSTRACT

A weather strip includes an installation base member and a seal member. The installation base member couples to a flange of at least one of a peripheral edge of a panel of an automobile or a peripheral edge of an opening of an automobile body of the automobile. The seal member is integrally molded with the installation base member and makes elastic contact with the other one of the peripheral edge of the opening or the peripheral edge of the panel when the panel is in a closed position. The seal member has a coating film formed on a surface. The coating film is prepared by adding a filler to a base. The filler has an average particle size that falls within a range of 15 to 20 μm and a deformation strength of not more than 0.1 MPa at 10% strain.

### CROSS REFERENCE TO RELATED APPLICATION

This application claims the benefit under 35 USC § 119 of JP Patent Applications 2024-134712 filed Aug. 10, 2024 and 2024-187000 filed Oct. 23, 2024, the entire disclosure of which is incorporated herein by reference.

### BACKGROUND INFORMATION

The present invention relates to a weather strip that couples to a flange of at least one of a peripheral edge of a panel or a peripheral edge of an opening of an automobile body of an automobile. The panel includes, for example, a side door, a back door, a trunk lid, and a hood. When the panel is in a closed position, the weather strip seals a gap between the panel and the automobile body by making elastic contact with the automobile body or the panel.

A weather strip (door weather strip) 200 illustrated in FIG. 1 and FIG. 2 has been used commonly. The weather strip 200 includes an installation base member 10 and a hollow seal member 20. The installation base member 10 couples to a flange of a peripheral edge of a panel 1, which is, for example, a door of the automobile. The hollow seal member 20 is integrally molded with the installation base member 10 and has a coating film 50 formed on the surface. The hollow seal member 20 makes elastic contact with a peripheral edge of an opening of an automobile body 2 of the automobile when the panel 1 is in the closed position (see, for example, Japanese Patent No. 7418641).

To improve a noise prevention performance, adding a filler such as silicone particles or polyurethane gel particles to the coating film 50 on the weather strip 200 has been known (see, Japanese unexamined Patent Publication Nos. 2009-1710 and 2000-313234). The noise is a creak generated by the slidable contact between the automobile body and the weather strip under the oscillation when the automobile is traveling. The noise tends to be generated when the weather strip is slightly wet in the rain, so-called semi-wet, and is one of the causes for the deterioration in quality of the automobile. Adding the filler improves slidability and decreases generation of the creak.

As evident from Table 1, the filler that has a larger particle size is improved in the noise prevention performance, but tends to be inferior to the filler that has a smaller particle size in a waterproof performance.

This is conceivably because a small space is produced between the filler on the surface of the coating film 50 and the automobile body 2 when the panel 1 is in the closed position and the weather strip 200 makes elastic contact with the automobile body 2. More specifically, as illustrated in FIG. 3A, the filler that has the smaller particle size produces a smaller space such that a smaller amount of water enters the smaller space, and is superior to the filler that has the larger particle size in the waterproof performance. As illustrated in FIG. 3B, the filler that has the larger particle size, on the other hand, produces a larger space, and is inferior to the filler that has the smaller particle size in the waterproof performance.

TABLE 1

| | noise prevention | waterproof |
|---|---|---|
| filler particles in coating film | performance* | performance |
| none | X | ◯ |
| smaller particle size | Δ | Δ |
| larger particle size | ◯ | X |

*creak under semi-wet

Traditional seal members, which have the coating film with the filler formed on the surface, suffer from trade-off characteristics between the noise prevention performance and the waterproof performance.

To solve the above problems, it is an object of the present invention to provide a weather strip that would keep the waterproof performance as well as the noise prevention performance if the coating film formed on the surface of the seal member includes the filler.

### SUMMARY OF THE INVENTION

To achieve the above object, an aspect of the present invention provides a weather strip (200). The weather strip (200) includes an installation base member (10), a seal member (20), and a coating film (50).

The installation base member (10) couples to a flange of at least one of a peripheral edge of a panel (1) of an automobile or a peripheral edge of an opening of an automobile body (2) of the automobile.

The seal member (20) is integrally molded with the installation base member (10). The seal member (20) makes elastic contact with the other one of the peripheral edge of the opening or the peripheral edge of the panel (1) when the panel (1) is in a closed position. The seal member (20) has the coating film (50) formed on the surface.

The coating film (50) is prepared by adding a filler (70) to a base (60). The filler (70) has an average particle size that falls within a range of 15 to 20 μm and a deformation strength of not more than 0.1 MPa at 10% strain.

Another aspect of the present invention provides a weather strip (200). The weather strip (200) includes an installation base member (10), a seal member (20), and a coating film (50).

The installation base member (10) couples to a flange of at least one of a peripheral edge of a panel (1) of an automobile or a peripheral edge of an opening of an automobile body (2) of the automobile.

The seal member (20) is integrally molded with the installation base member (10). The seal member (20) makes elastic contact with the other one of the peripheral edge of the opening or the peripheral edge of the panel (1) when the panel (1) is in a closed position. The seal member (20) has the coating film (50) formed on the surface.

The coating film (50) is prepared by adding a filler (70) to a base (60). The filler (70) has particles of various sizes. The filler (70 (70A)) that protrudes the most from the base (60) has a particle size that falls within a range of 15 to 20 μm and a deformation strength of not more than 0.1 MPa at 10% strain.

Another aspect of the present invention provides a weather strip (200). The weather strip (200) includes an installation base member (10), a seal member (20), and a coating film (50).

The installation base member (10) couples to a flange of at least one of a peripheral edge of a panel (1) of an automobile or a peripheral edge of an opening of an automobile body (2) of the automobile.

The seal member (20) is integrally molded with the installation base member (10). The seal member (20) makes elastic contact with the other one of the peripheral edge of the opening or the peripheral edge of the panel (1) when the panel (1) is in a closed position. The seal member (20) has the coating film (50) formed on the surface.

The coating film (50) is prepared by adding a filler (70) to a base (60). The filler (70) has particles of various sizes. The filler (70) contained in the base (60) has the maximum particle size that falls within a range of 15 to 20 μm and a deformation strength of not more than 0.1 MPa at 10% strain.

Another aspect of the present invention provides a weather strip (200). The weather strip (200) includes an installation base member (10), a seal member (20), and a coating film (50).

The installation base member (10) couples to a flange of at least one of a peripheral edge of a panel (1) of an automobile or a peripheral edge of an opening of an automobile body (2) of the automobile.

The seal member (20) is integrally molded with the installation base member (10). The seal member (20) makes elastic contact with the other one of the peripheral edge of the opening or the peripheral edge of the panel (1) when the panel (1) is in a closed position. The seal member (20) has the coating film (50) formed on the surface.

The coating film (50) is prepared by adding a filler (70) to a base (60). The filler (70) has particles of various sizes. The filler (70 (70A)) provided closest to the exterior from the surface of the seal member (20) has a particle size that falls within a range of 15 to 20 μm, and a deformation strength of not more than 0.1 MPa at 10% strain.

In addition, according to an aspect of the present invention, the base (60) has a hardness of not more than 46 MPa under a nanoindentation tester with the maximum indentation load applied to an indenter set to 20 μN.

In addition, according to an aspect of the present invention, the base (60) has a thickness(S) of not more than 20 μm.

Symbols in parentheses show constituents or items corresponding to the drawings.

According to the present invention, the installation base member of the weather strip couples to the flange of at least one of the peripheral edge of the panel or the peripheral edge of the opening. The seal member is integrally molded with the installation base member and makes elastic contact with the other one of the peripheral edge of the opening or the peripheral edge of the panel when the panel is in the closed position. The seal member has the coating film formed on the surface, which is prepared by adding the filler to the base. The filler has a larger average particle size that falls within the range of 15 to 20 μm. This improves a noise prevention performance of the seal member.

In addition, the filler has a smaller deformation strength of not more than 0.1 MPa at 10% strain. The filler is deformed when sandwiched between the seal member and the opposite member. The opposite member is the peripheral edge of the opening when the weather strip couples to the peripheral edge of the panel such as a door, or the peripheral edge of the panel when the weather strip couples to the peripheral edge of the opening. This narrows a space between the filler and the opposite member, and prevents degradation in a waterproof performance.

The filler that has the larger particle size and the smaller deformation strength at 10% strain provides both the noise prevention performance and the waterproof performance.

According to the present invention, the installation base member of the weather strip couples to the flange of at least one of the peripheral edge of the panel or the peripheral edge of the opening. The seal member is integrally molded with the installation base member and makes elastic contact with the other one of the peripheral edge of the opening or the peripheral edge of the panel when the panel is in the closed position. The seal member has the coating film formed on the surface, which is prepared by adding the filler to the base. The filler has particles of various sizes. The filler that protrudes the most from the base or is provided closest to the exterior from the surface of the seal member has a larger particle size that falls within the range of 15 to 20 μm. This improves the noise prevention performance of the seal member.

In addition, the filler has the smaller deformation strength of not more than 0.1 MPa at 10% strain. The filler is deformed when sandwiched between the seal member and the opposite member. The opposite member is the peripheral edge of the opening when the weather strip couples to the peripheral edge of the panel such as the door, or the peripheral edge of the panel when the weather strip couples to the peripheral edge of the opening. This narrows the space between the filler and the opposite member, and prevents the degradation in the waterproof performance.

The filler that has the larger particle size and the smaller deformation strength at 10% strain provides both the noise prevention performance and the waterproof performance.

According to the present invention, the installation base member of the weather strip couples to the flange of at least one of the peripheral edge of the panel or the peripheral edge of the opening. The seal member is integrally molded with the installation base member and makes elastic contact with the other one of the peripheral edge of the opening or the peripheral edge of the panel when the panel is in the closed position. The seal member has the coating film formed on the surface, which is prepared by adding the filler to the base. The filler has particles of various sizes. The filler contained in the base has the larger maximum particle size that falls within the range of 15 to 20 μm. This improves the noise prevention performance of the seal member.

In addition, the filler has the smaller deformation strength of not more than 0.1 MPa at 10% strain. The filler is deformed when sandwiched between the seal member and the opposite member. The opposite member is the peripheral edge of the opening when the weather strip couples to the peripheral edge of the panel such as a door, or the peripheral edge of the panel when the weather strip couples to the peripheral edge of the opening. This narrows the space between the filler and the opposite member, and prevents the degradation in the waterproof performance.

The filler that has the larger particle size and the smaller deformation strength at 10% strain provides both the noise prevention performance and the waterproof performance.

In addition, the base has the hardness of not more than 46 MPa under the nanoindentation tester with the maximum indentation load applied to the indenter set to 20 μN. This further improves the noise prevention performance.

In addition, the filler has the average particle size that falls within the range of 15 to 20 μm and the base has the thickness of not more than 20 μm. This reduces the amount of the filler that is not exposed from the surface of the coating film such that the filler fully performs the function.

### BRIEF DESCRIPTION OF THE DRAWINGS

FIG. 1 is a cross-sectional view of a weather strip 200 according to an embodiment of the present invention.

FIG. 2 is a cross-sectional view of the weather strip 200 illustrated in FIG. 1 as bent.

FIG. 3A and FIG. 3B are schematic enlarged cross-sectional views taken along line III-III in FIG. 2 showing the main components of the weather strip 200 with a traditional coating film.

FIG. 4 is a schematic enlarged cross-sectional view taken along line III-III in FIG. 2 showing the main components of the weather strip 200 with a coating film according to an embodiment of the present invention.

FIG. 5 is a schematic enlarged cross-sectional view showing the main components of the weather strip 200 with a coating film according to another embodiment of the present invention.

FIG. 6 is an enlarged cross-sectional view showing the surface of the coating film illustrated in FIG. 5 worn down.

### DETAILED DESCRIPTION

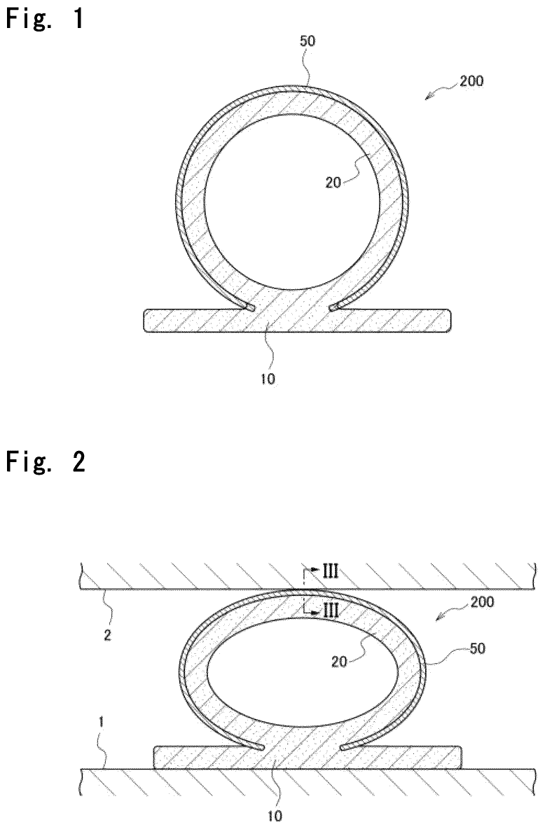

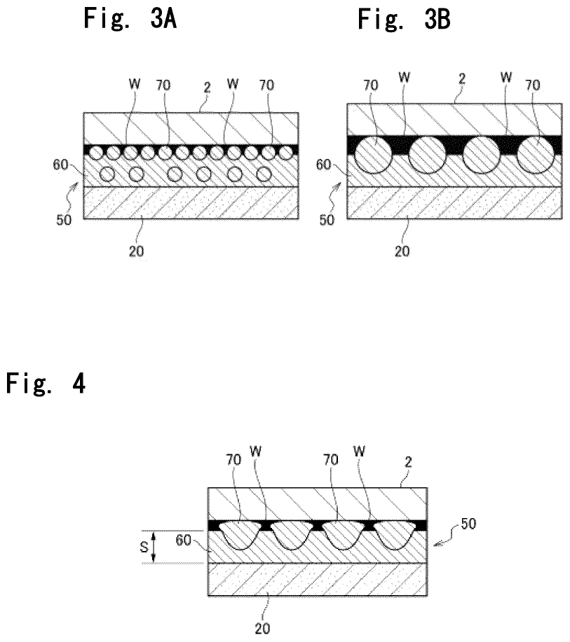

Referring to FIG. 1, FIG. 2, and FIG. 4, a weather strip 200 according to an embodiment of the present invention will be described.

The weather strip 200 includes an installation base member 10 and a hollow seal member 20. The installation base member 10 couples to a flange of a peripheral edge of a panel 1 of an automobile, which is a side door 1 in this embodiment. The hollow seal member 20 is integrally molded with the installation base member 10. The hollow seal member 20 makes elastic contact with a peripheral edge of an opening of an automobile body 2 of the automobile when the side door 1 is in a closed position. The hollow seal member 20 is formed by sponge rubber. The hollow seal member 20 has a coating film 50 formed on the surface.

The drawings illustrate a thickness of the coating film 50 merely for better understanding of the invention. Actually, the coating film 50 has the thickness expressed in micrometer (μm) and the hollow seal member 20 has the thickness expressed in millimeter (mm). The coating film 50 has the thickness substantially one thousandth the thickness of the hollow seal member 20.

In this embodiment, the sponge rubber used as the hollow seal member 20 has the specific gravity of 0.40.

The specific gravity of the hollow seal member 20 is determined by splitting the hollow seal member 20, by cutting out for example, and subjecting the hollow seal member 20 to the water immersion displacement method.

In this embodiment, the hollow seal member 20 is formed by a rubber material mainly including ethylene-propylene-diene rubber (EPDM). In some embodiments, the hollow seal member 20 is formed by rubber materials mainly composed of synthetic rubbers other than EPDM or various thermoplastic elastomers.

As illustrated in FIG. 4, the hollow seal member 20 has the coating film 50 formed on the surface. The coating film 50 is prepared by adding a filler 70 to a base 60. The filler 70 has an average particle size that falls within a range of 15 to 20 μm and a deformation strength of not more than 0.1 MPa at 10% strain. In this embodiment, the filler 70 has the average particle size of 20 μm and the deformation strength of 0.1 MPa at 10% strain.

This is because the evaluation revealed that the filler with a larger average particle size, in the order of 8 μm, 15 μm, 20 μm in Table 2, improves a noise prevention performance and the filler with a smaller deformation strength at 10% strain, in the order of 25.0 MPa, 10.0 MPa, 0.5 MPa, 0.1 MPa in Table 3, improves a waterproof performance.

The deformation strength of the filler at 10% strain is measured using the NS-A300 micro-particle crush strength tester, manufactured by Nano Seeds Corporation in accordance with JIS Z 8844:2019 Measurement Method for the Crushing Strength and Deformation Strength of Micro-particles. The particle size is measured using an image analysis software by measuring the diameter (length) of the particle sandwiched between an indenter and a plane where the particles adhere by referring to an image taken during the measurement.

In this embodiment, the filler 70 is silicone particles. However, the filler 70 is not limited to the silicone particles. In some embodiments, the filler 70 is another material such as polyethylene, nylon, acrylic, urethane, fluorine. In this modification, it is only required that the filler 70 has the deformation strength of not more than 0.1 MPa at 10% strain.

In this embodiment, the base 60 is prepared by a water-based polyurethane resin (30% solid content) blended with a carbodiimide-type curing agent. However, the base 60 is not limited to this.

The base 60 preferably has a hardness of not more than 46 MPa. In this embodiment, the base 60 has the hardness of 46 MPa.

This is because the evaluation revealed that the base 60 with a lower hardness, in the order of 205 MPa, 122 MPa, 46 MPa, 26 MPa in Table 4, improves the noise prevention performance.

The hardness of the base 60 is measured using Anton Paar GmbH, UNHT 3 as the testing machine (nanoindentation tester) and Berkovich indenter as the indenter, under the maximum indentation load of 20 μN, load or unload speed of 600 μN/min in accordance with ISO14577. The hollow seal member 20 is cut into a square 10 mm by 10 mm as a measurement sample. The measurement sample has a thickness of substantially 1.8 mm.

The weight ratio of the filler 70 to the base 60 is preferably 1 to 6 or less. In this embodiment, the weight ratio is 1 (filler 70) to 2 (base 60).

“Evaluation of noise prevention performance” in Table 2 and Table 4 is the result of sensory evaluation of the creak generated under semi-wet. In the Tables, “O” is no noise, “Δ” is slight noise, and “X” is noisy.

“Evaluation of waterproof performance” in Table 3 is the result of the evaluation of the water leak when the weather strip makes elastic contact with the opposite surface in a reproduced rain, to measure the time from the supply of water to the passage. In Table 3, “Δ” is not less than 30 minutes, “A” is 10 to less than 30 minutes, and “X” is less than 10 minutes.

The base 60 preferably has a thickness S of not more than 20 μm to expose the filler 70.

More preferably the thickness S is not more than 17 μm, and even more preferably not more than 15 μm. In this embodiment, the thickness S is 20 μm. The minimum of the thickness S is not limited. To maintain durability of the hollow seal member 20, the thickness S is preferably not less than 1 μm, more preferably not less than 2 μm, and even more preferably not less than 3 μm.

The thickness S is measured using the image analysis software by measuring the vertical length of the base 60 relative to the hollow seal member 20 on the measurement point of an image of the cross-sectional surface of the hollow seal member 20, enlarged by a digital microscope.

TABLE 2
Evaluation of noise prevention performance

| deformation strength | average particle size [μm] | | |
|---|---|---|---|
| at 10% strain [MPa] | 8 | 15 | 20 |
| 0.1 | Δ | ◯ | ◯ |
| 0.5 | X | Δ | ◯ |
| 10 | X | X | ◯ |
| 25 | X | X | ◯ |

TABLE 3
Evaluation of waterproof performance

| deformation strength | average particle size [μm] | | |
|---|---|---|---|
| at 10% strain [MPa] | 8 | 15 | 20 |
| 0.1 | ◯ (60 minutes | ◯ (60 minutes | ◯ (60 minutes |
| | no water leak) | no water leak) | no water leak) |
| 0.5 | Δ (18 minutes) | X (7 minutes) | X (1 minute) |
| 10 | Δ (15 minutes) | X (5 minutes) | X (1 minute) |
| 25 | Δ (18 minutes) | X (4 minutes) | X (1 minute) |

TABLE 4
Evaluation of noise prevention performance

| Hardness of base | average particle size [μm] | | |
|---|---|---|---|
| [MPa] | 8 | 15 | 20 |
| 26 | ◯ | ◯ | ◯ |
| 46 | Δ | ◯ | ◯ |
| 122 | X | X | X |
| 205 | X | X | X |

The filler 70 has a larger average particle size that falls within a range of 15 to 20 μm. This improves the noise prevention performance of the hollow seal member 20 when the hollow seal member 20 makes elastic contact with the peripheral edge of the opening.

In addition, the filler 70 has a smaller deformation strength of not more than 0.1 MPa at 10% strain. As illustrated in FIG. 4, the filler 70 is deformed when sandwiched between the hollow seal member 20 and the peripheral edge of the opening as the opposite member. This narrows a space between the filler 70 and the peripheral edge of the opening as the opposite member, and prevents degradation in the waterproof performance.

The filler 70, which has the larger particle size and the smaller deformation strength at 10% strain, provides both the noise prevention performance and the waterproof performance.

In addition, the base 60 has the hardness of not more than 46 MPa. This further improves the noise prevention performance.

In addition, the filler 70 has the average particle size that falls within the range of 15 to 20 μm and the base 60 has the thickness of not more than 20 μm. This reduces the amount of the filler 70 that is not exposed from the surface of the coating film 50 such that the filler 70 fully performs the function.

In this embodiment, the filler 70 is a single type of silicone particles. However, the filler 70 is not limited to the single type. In some embodiments, the filler 70 is multiple types of silicone particles combined with other materials such as polyethylene, nylon, acrylic, urethane, fluorine, or combinations of these materials other than silicone. In this modification, it is only required that the filler 70 has the deformation strength of not more than 0.1 MPa at 10% strain.

Table 5 and Table 6 show the results of evaluation of the noise prevention performance and the waterproof performance when the filler 70 is the single type of silicone particles (paint A) and when multiple fillers 70 are combined (paints B, C, D, E).

TABLE 5

| | formulation [part by weight] | | | | |
|---|---|---|---|---|---|
| component | Paint A | Paint B | Paint C | Paint D | Paint E |
| main ingrediants | 100 | 100 | 100 | 100 | 100 |
| curing agent | 5 | 5 | 5 | 5 | 5 |
| ion-exchange water | 30 | 30 | 30 | 30 | 30 |
| filler A | 30 | 10 | 10 | 10 | 10 |
| filler B | — | 20 | — | — | — |
| filler C | — | — | 20 | — | — |
| filler D | — | — | — | 20 | — |
| filler E | — | — | — | — | 20 |
| total | 165 | 165 | 165 | 165 | 165 |

TABLE 6

| | | deformation strength | average particle |
|---|---|---|---|
| filler | material | at 10% strain [MPa] | size [μm] |
| A | silicone | 0.1 | 20 |
| B | silicone | 0.1 | 10 |
| C | PMMA | 0.5 | 10 |
| D | PMMA | 10 | 10 |
| E | PMMA | 25 | 10 |

Paint A is a mixture of the base 60 with ion-exchange water and filler A. The base 60 includes an aqueous polyurethane resin (solid content 30%) blended with a carbodiimide-type curing agent. The filler A is silicone particles that have an average particle size of 20 μm and a deformation strength of 0.1 MPa at 10% strain. The formulation consists of 100 parts by weight of the aqueous polyurethane resin as the main agent, 5 parts by weight of the curing agent, 30 parts by weight of the ion-exchange water, and 30 parts by weight of the filler A, for a total of 165 parts by weight.

Paint B is a mixture of the base 60 with the ion-exchange water, the filler A, and filler B. The base 60 includes the aqueous polyurethane resin (solid content 30%) blended with the carbodiimide-type curing agent. The filler A is the silicone particles that have the average particle size of 20 μm and the deformation strength of 0.1 MPa at 10% strain. The filler B is silicone particles that have the average particle size of 10 μm and the deformation strength of 0.1 MPa at 10% strain. The formulation consists of 100 parts by weight of the aqueous polyurethane resin as the main agent, 5 parts by weight of the curing agent, 30 parts by weight of the ion-exchange water, 10 parts by weight of the filler A, and 20 parts by weight of the filler B, for a total of 165 parts by weight.

Paint C is a mixture of the base 60 with the ion-exchange water, the filler A, and filler C. The base 60 includes the aqueous polyurethane resin (solid content 30%) blended with the carbodiimide-type curing agent. The filler A is the silicone particles that have the average particle size of 20 μm and the deformation strength of 0.1 MPa at 10% strain. The filler C is relatively soft particles made of acrylic resin (PMMA) that have the average particle size of 10 μm and the deformation strength of 0.5 MPa at 10% strain. The formulation consists of 100 parts by weight of the aqueous polyurethane resin as the main agent, 5 parts by weight of the curing agent, 30 parts by weight of the ion-exchange water, 10 parts by weight of the filler A, and 20 parts by weight of the filler C, for a total of 165 parts by weight.

Paint D is a mixture of the base 60 with the ion-exchange water, the filler A, and filler D. The base 60 includes the aqueous polyurethane resin (solid content 30%) blended with the carbodiimide-type curing agent. The filler A is silicone particles that have the average particle size of 20 μm and the deformation strength of 0.1 MPa at 10% strain. The filler D is particles of an intermediate hardness made of acrylic resin (PMMA) that have the average particle size of 10 μm and the deformation strength of 10.0 MPa at 10% strain. The formulation consists of 100 parts by weight of the aqueous polyurethane resin as the main agent, 5 parts by weight of the curing agent, 30 parts by weight of the ion-exchange water, 10 parts by weight of the filler A, and 20 parts by weight of the filler D, for a total of 165 parts by weight.

Paint E is a mixture of the base 60 with the ion-exchange water, the filler A, and filler E. The base 60 includes the aqueous polyurethane resin (solid content 30%) blended with the carbodiimide-type curing agent. The filler A is silicone particles that have the average particle size of 20 μm and the deformation strength of 0.1 MPa at 10% strain. The filler E is relatively hard particles made of acrylic resin (PMMA) that have the average particle size of 10 μm and the deformation strength of 25.0 MPa at 10% strain. The formulation consists of 100 parts by weight of the aqueous polyurethane resin as the main agent, 5 parts by weight of the curing agent, 30 parts by weight of the ion-exchange water, 10 parts by weight of the filler A, and 20 parts by weight of the filler E, for a total of 165 parts by weight.

Table 7 shows the favorable results of evaluation of the noise prevention performance and the waterproof performance when the Paint A, Paint B, Paint C, Paint D, or Paint E is applied on the surface of the hollow seal member 20. Conditions of the evaluation and meaning of the symbols in Table 7 are the same as Tables 2, 3, 4.

TABLE 7

| | | noise prevention | waterproof |
|---|---|---|---|
| Paint | blended filler | performance | performance |
| A | A | ◯ | ◯ |
| B | A and B | ◯ | ◯ |
| C | A and C | ◯ | ◯ |
| D | A and D | ◯ | ◯ |
| E | A and E | ◯ | ◯ |

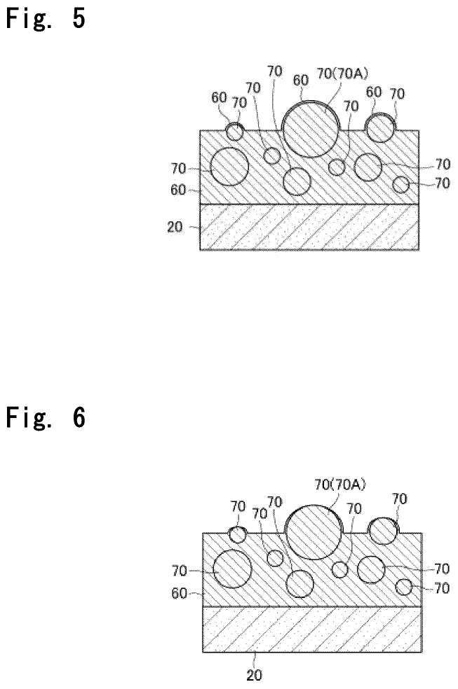

As illustrated in FIG. 5, the hollow seal member 20 may have an uneven surface with the filler 70 of various particle sizes protruding from the surface.

The filler 70 as well as the surface of the hollow seal member 20 is covered with a film of the base 60 as illustrated in FIG. 5 at the time of shipping of the product (weather strip 200). The filler 70 can be exposed from the film as illustrated in FIG. 6, which is worn down after repeated elastic contact of the part of the film with the peripheral edge of the opening or the peripheral edge of the panel 1 including the door.

In this embodiment, the filler 70 has the average particle size of 20 μm and the deformation strength of 0.1 MPa at 10% strain. Alternatively, the filler 70 may have a maximum particle size that falls within a range of 15 to 20 μm, and the deformation strength of not more than 0.1 MPa at 10% strain.

Protruding the filler 70, which is improved in the noise prevention performance and the waterproof performance, from the position where the hollow seal member 20 makes elastic contact with the peripheral edge of the opening is effective. In this connection, the filler 70 (70A) in the coating film 50, which protrudes the most from the base 60 as illustrated in FIG. 6, preferably has the particle size that falls within the range of 15 to 20 μm and the deformation strength of not more than 0.1 MPa at 10% strain. Alternatively, the filler 70 (70A), which is provided closest to the exterior from the surface of the seal member 20 as illustrated in FIG. 5 and FIG. 6, preferably has the particle size that falls within the range of 15 to 20 μm and the deformation strength of not more than 0.1 MPa at 10% strain. FIG. 5 has the film of the base 60 provided closest to the exterior, and therefore, the most prominent filler 70 (70A) in FIG. 5, which protrudes the most from the surface of the seal member 20, is the filler 70 that is provided closest to the exterior from the surface of the seal member 20.

In FIG. 6, the filler 70 (70A), which protrudes the most from the base 60, has the particle size that falls within the range of 15 to 20 μm and the deformation strength of not more than 0.1 MPa at 10% strain. Alternatively, the filler 70 (70A), which protrudes the most from the base 60, may have the particle size of not less than 15 μm without an upper limit and the deformation strength of not more than 0.1 MPa at 10% strain.

In this embodiment, the weather strip 200 couples to the flange of the peripheral edge of the side door 1 and makes elastic contact with the peripheral edge of the opening. In some embodiments, the weather strip 200 couples to the flange of the peripheral edge of the opening and makes elastic contact with the peripheral edge of the side door 1 when the side door 1 is in the closed position. In some embodiments, the hollow seal member 20 is solid as a lip. The material of the hollow seal member 20 is not limited to the sponge rubber. In some embodiments, hollow seal member 20 is formed by a single layer of solid rubber or a multilayer of solid rubber and sponge rubber. In some embodiments, the sponge rubber has the specific gravity of more than or less than 0.40. The weather strip 200 is applicable to every weather strip, which couples to, for example, the flange of the panels of the automobile, e.g., back doors, trunk lids, and hoods.

We claim:

1. A weather strip comprising:
an installation base member configured to be operably coupled to a flange of at least one of a peripheral edge of a panel of an automobile or a peripheral edge of an opening of an automobile body of the automobile;
a seal member integrally molded with the installation base member, the seal member being configured to make elastic contact with the other one of the peripheral edge of the opening or the peripheral edge of the panel when the panel is in a closed position, the seal member having a coating film formed on a surface thereof; and
the coating film prepared by adding a filler to a base, the filler having an average particle size that falls within a range of 15 to 20 μm and a deformation strength of not more than 0.1 MPa at 10% strain.

2. A weather strip comprising:
an installation base member configured to be operably coupled to a flange of at least one of a peripheral edge of a panel of an automobile or a peripheral edge of an opening of an automobile body of the automobile;
a seal member integrally molded with the installation base member, the seal member being configured to make elastic contact with the other one of the peripheral edge of the opening or the peripheral edge of the panel when the panel is in a closed position, the seal member having a coating film formed on a surface thereof; and
the coating film prepared by adding a filler to a base, the filler having particles of various sizes, the filler that protrudes the most from the base having a particle size that falls within a range of 15 to 20 μm and a deformation strength of not more than 0.1 MPa at 10% strain.

3. A weather strip comprising:
an installation base member configured to be operably coupled to a flange of at least one of a peripheral edge of a panel of an automobile or a peripheral edge of an opening of an automobile body of the automobile;
a seal member integrally molded with the installation base member, the seal member being configured to make elastic contact with the other one of the peripheral edge of the opening or the peripheral edge of the panel when the panel is in a closed position, the seal member having a coating film formed on a surface thereof; and
the coating film prepared by adding a filler to a base, the filler having particles of various sizes, the filler contained in the base having a maximum particle size that falls within a range of 15 to 20 μm and a deformation strength of not more than 0.1 MPa at 10% strain.

4. A weather strip comprising:
an installation base member configured to be operably coupled to a flange of at least one of a peripheral edge of a panel of an automobile or a peripheral edge of an opening of an automobile body of the automobile;
a seal member integrally molded with the installation base member, the seal member being configured to make elastic contact with the other one of the peripheral edge of the opening or the peripheral edge of the panel when the panel is in a closed position, the seal member having a coating film formed on a surface thereof; and
the coating film prepared by adding a filler to a base, the filler having particles of various sizes, the filler provided closest to an exterior from the surface of the seal member has a particle size that falls within a range of 15 to 20 μm and a deformation strength of not more than 0.1 MPa at 10% strain.

5. The weather strip as claimed in claim 1, wherein
the base has a hardness of not more than 46 MPa under a nanoindentation tester with a maximum indentation load applied to an indenter set to 20 μN.

6. The weather strip as claimed in claim 1, wherein
the base has a thickness of not more than 20 μm.

7. The weather strip as claimed in claim 5, wherein
the base has a thickness of not more than 20 μm.

8. The weather strip as claimed in claim 2, wherein
the base has a hardness of not more than 46 MPa under a nanoindentation tester with a maximum indentation load applied to an indenter set to 20 μN.

9. The weather strip as claimed in claim 3, wherein
the base has a hardness of not more than 46 MPa under a nanoindentation tester with a maximum indentation load applied to an indenter set to 20 μN.

10. The weather strip as claimed in claim 4, wherein
the base has a hardness of not more than 46 MPa under a nanoindentation tester with a maximum indentation load applied to an indenter set to 20 μN.

11. The weather strip as claimed in claim 2, wherein
the base has a thickness of not more than 20 μm.

12. The weather strip as claimed in claim 3, wherein
the base has a thickness of not more than 20 μm.

13. The weather strip as claimed in claim 4, wherein
the base has a thickness of not more than 20 μm.

14. The weather strip as claimed in claim 8, wherein
the base has a thickness of not more than 20 μm.

15. The weather strip as claimed in claim 9, wherein
the base has a thickness of not more than 20 μm.

16. The weather strip as claimed in claim 10, wherein
the base has a thickness of not more than 20 μm.
